(19) United States
(12) Patent Application Publication
(10) Pub. No.: US 2008/0053053 A1
(43) Pub. Date: Mar. 6, 2008

(54) Recycling grass mulching device for rotary lawn mower

(76) Inventors: Glenn A. Fodor, Hampton, NJ (US); Virginia M. Cunningham, Hampton, NJ (US)

Correspondence Address: Kenneth P. Glynn, 24 Mine Street, Flemington, NJ, 08822, US

(21) Appl. No.: 11/511,770

(22) Filed: Aug. 29, 2006

(51) Int. Cl. A01D 34/00

(52) U.S. Cl. 56/13.7

(57) ABSTRACT

A recycling grass mulching device for a rotary lawn mower has (a.) a main housing having a grass ingress port and a grass egress port; (b.) a mulching device contained within the main housing, the mulching device including a central shaft, a central shaft drive take-off, and a plurality of mulching lines extending outwardly and away from the central shaft wherein the drive take-off is selected from the group consisting of a pulley attachment, a gear attachment, a chain attachment, and a drive shaft attachment. The lines are typically heavy duty weed whacker type lines, i.e. thick, flexible plastic cord, or metal wire or rod or strip, flexible or rigid. The recycling grass mulcher main housing is adapted to be mounted onto a rotary lawn mower, with the grass ingress port being connected to a grass cutting area of the rotary lawn mower, e.g. the grass is expelled from cutting chamber(s) into the mulching device. The mulching device may be a lawn mower retrofit or attachment or it may be an integral part of the lawn mower.

### BACKGROUND OF INVENTION

a. Field of Invention

The invention relates generally to devices for grass cutting, and more particularly to rotary lawn mowers with a mulching device connected thereto or as an integral part thereof. In preferred embodiments, the mulcher is located so as to discharge mulched grass in front of the direction of travel of the rotary lawn mower to enhance the fine cutting and mulching of the grass.

b. Description of Related Art

The following patents are representative of recycling grass mulching device for rotary lawn mower:

U.S. Pat. No. 5,890,354 to Richard D. Dednar the invention provides a rotary lawn mower with an improved mulching deck. The rotary lawn mower comprises a plurality of sets of cutting blades. Each of the blade sets includes a lower, leading blade and an upper, trailing blade. The lower blade has a leading cutting edge and an upwardly angled trailing edge. The upper trailing blade extends at an angle relative to the leading blade and has a leading cutting edge for cutting clippings deflected and upwardly by the upwardly angled trailing edge of the leading blade. The lawn mower further comprises a mulching deck including a plastic, dent resistant, rust proof insert which is positioned in the deck. The insert defines a plurality of recesses. A blade set mounted for rotation about an axis of each roof recess. The insert includes an integral, arcuate baffle extending downwardly adjacent the periphery of one of the recesses impending airflow from the one recess to an adjacent recess. The insert also includes an integral projecting in one of the left and right recesses such that the recess has a decreased height in the area of the projection. The projection prevents downward flow of air that would otherwise result from the converging air from two adjacent blade sets. The lawn mower further comprises a front deflector removable mounted on the front portion of the deck side wall to allow venting of air but not discharfe of the clippings from the front portion of the deck.

U.S. Pat. No. 4,435,949 to Richard A. Heismann a mulching adapter for use in a rotary lawn mower having a blade housing including a grass discharge chute through which cut grass is adapted to be discharged. A grass mulching assembly is insertable through the discharge outlet into the discharge chute for blocking the discharge chute. The grass mulching assembly includes an inner portion defining a surface facing the rotary cutting blade and forming a generally continuous surface with the blade housing interior surface.

U.S. Pat. No. 4,135,351 to Sahag C. Akgulian a rotary lawn mower grass mulcher assembly having a mower housing with a discharge opening over which two plates are disposed with each plate having two airholes extending therethrough and with the holes being aligned offset between the two plates. Air is permitted to escape through the holes, but grass and like debris does not have free passage through the holes, and thus the mulcher assembly causes the grass clippings to remain in the mower housing for mulching or recutting action. The two plates are assembled together, and the plates are spaced apart with one thereof toward the outer end of the housing opening being angled downwardly and outwardly, all for permitting the passage of air but deflecting any debris downward to the ground.

U.S. Pat. No. 3,531,923 to Manford S. De Lay A combination mower and mulcher is provided having attachments so it can be utilized either as a standard mowing machine or as a combination mower and mulcher. Alternatively, other attachments can be added to convert it to a leaf mulcher. The unit includes a rotating cutter, a plate over the cutter, a skirt attached to the plate and extending down and substantially around the cutter to shield the cutter, and means mounted on the plate for rotating the cutter. A plurality of comparatively large openings are located in the skirt for discharge mulched vegetation. A shield is attachable to the skirt for covering these large openings and an additional cutting blade and band with smaller openings can be attached for mulching leaves. An overskirt can be attached to obviate danger from hard objects discharged by the unit.

U.S. Pat. No. 2,942,400 to Jack C. Sylvester In a rotary lawn mower in combination, a housing having a top, a vertical power shaft depending from said top, a blade mounted on said shaft for horizontal rotation, said blade having downwardly offset cutting edges oppositely disposed for a portion of its length at the outer ends thereof a vertical skirt depending from the perimeter of said top disposed exteriorly of the outer ends of said blade and extending below the ends thereof, and a concentric cylindrical baffle depending from the top of said housing at the approximate inner ends of said downwardly offset cutting edges to a point below the non-offset portion of said blade to form a circular cutting retaining channel.

Notwithstanding the prior art, the present invention is neither taught nor rendered obvious thereby.

### SUMMARY OF INVENTION

The invention solves the problems and overcomes the drawbacks and deficiencies of prior art mulching devices by providing the present invention mulcher with the rotary lawn mower, by having front end preferred discharge for recutting and mulching the discharged grass and by providing effective and efficient inter mulching mechanisms.

In some preferred embodiments, the present invention is a recycling grass mulching device for a rotary lawn mower, which includes: (a.) a main housing having a grass ingress port and a grass egress port; (b.) a mulching device contained within the main housing, the mulching device including a central shaft, a central shaft drive take-off, and a plurality of mulching members extending outwardly and away from the central shaft wherein the drive take-off is selected from the group consisting of a pulley attachment, a gear attachment, a chain attachment, and a drive shaft attachment. The Mulching members may be blades or lines. The blades are preferably metal blades. The lines are typically heavy-duty weed whacker type lines, i.e. thick, flexible plastic cord, or metal wire or rod or strip, flexible or rigid. Either blades or lines or a combination of the two may be used.

In some preferred embodiments of the present invention, the recycling grass mulcher main housing is adapted to be mounted onto a rotary lawn mower, with the grass ingress port being connectable to a grass cutting area of the rotary lawn mower, e.g the grass is expelled from cutting chamber(s) into the mulching device.

In some preferred embodiments of the present invention, the grass ingress is positioned relative to the central shaft so as to feed grass cuttings at approximately a 90 degree angle to the central shaft.

In some preferred embodiments of the present invention, the central shaft may include a plurality of rows of the mulching members, especially lines. Preferably, the plurality of mulching lines is arranged in spiral fashion.

In some preferred embodiments of the present invention, the mulcher main housing is adapted to be attached on top of a rotary lawn mower with the grass egress port being directed to a front area of the rotary lawn mower.

In some preferred embodiments of the present invention, the grass egress port includes a deflector (or deflectors) that is adjustable such that it may be positioned in one of a plurality of possible directions. It is preferred to also utilize rotational nozzle arrangements, with or without the deflector(s). In some preferred embodiments of the present invention, the objective is to have a rotatable discharge nozzle and/or deflector(s) to offer front, left side and right side discharge positions. In some preferred embodiments of the present invention, the grass egress port deflector includes a hinge mechanism for multiple positioning thereof.

In some preferred embodiments of the present invention, the mulcher main housing is located within a housing of a rotary lawn mower. In such embodiments, the grass egress port is positioned to eject mulched grass in front of the rotary lawn mower. In other embodiments, the grass egress port is positioned to the side or is position adjustable.

In some preferred embodiments of the present invention, the invention is both a recycling grass mulching device and a rotary lawn mower. It includes: (a.) a rotary lawnmower, including a mower housing, a motor, a mower blade and a drive mechanism connecting the motor to the mower blade, and further including connection to a mulcher main housing grass ingress port; (b.) a mulcher main housing having a grass ingress port and a grass egress port, connected to the rotary lawn mower; (c.) a mulching device contained within the main housing, the mulching device including a central shaft, a central shaft drive take-off, and a plurality of mulching members extending outwardly and away from the central shaft wherein the drive take-off is selected from the group consisting of a pulley attachment, a gear attachment, a chain attachment, and a drive shaft attachment.

In some preferred embodiments of the present invention, the recycling grass mulching device for a rotary lawn mower of wherein the main housing is mounted in a position selected from the group consisting of atop the mower housing, in front of the mower housing and a combination thereof.

In some preferred embodiments of the present invention, the grass ingress is positioned relative to the central shaft so as to feed grass cuttings at approximately a 90 degree angle to the central shaft.

In some preferred embodiments of the present invention, the grass egress port is adjustable and includes a forward egress position, a left side egress position and a right side egress position.

In some preferred embodiments of the present invention, the mulcher main housing and the mower housing are located in the same plane and the mulcher main housing is positioned in front of the mower housing.

In some preferred embodiments, the present invention device may include a booster blower connected to that mulcher main housing to increase the outflow of cut mulched grass effluent.

In some preferred embodiments of the present invention, the mower housing includes a plurality of cutting blades located in a plurality of chambers with each of the plurality of chambers being connected to a grass ingress port of the mulcher main housing.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 illustrates a side view diagrammatic representation of one embodiment of a present invention grass mulching device and rotary lawn mower device;

FIG. 2 shows another side view diagrammatic representation of a different embodiment of a present invention grass mulching device and rotary lawn mower device;

FIG. 3 shows a side view of a present invention mulching device shaft and mulch lines in one preferred arrangement;

FIG. 4 shows a bottom view of a present invention mulching device with a disk shaft arrangement and FIG. 5 shows a partial cut side view thereof;

FIG. 6 shows a bottom view of a present invention mulcher and mower with a single plane deck and plural cutting chambers;

FIGS. 7 and 8 show side and top views of a present invention mulching device with an adjustable egress port nozzle and adjustable deflectors; and,

FIG. 9 shows a side cut view of another present invention mulching device with an auxiliary blower on top of the mulcher.

### DETAILED DESCRIPTION OF THE EMBODIMENTS

In preferred arrangements of the present invention, the device mulches grass right after it is cut, in the same pass, moving the cut grass directly from the cutting chamber to the mulcher, and discharging it back in front of the mower. By not mulching in the cutting chamber, the prior art problem of frequent clogging is eliminated. The need for raking and/or bagging and disposing of the cut grass are also eliminated, as the mulched product is deposited back onto the soil for rapid decomposition, due to the fineness of the product that is at least once recycled back into the device when it is discharged forwardly. By using the airflow of the mower to direct the cut grass to the mulcher, there is no need for a blower.

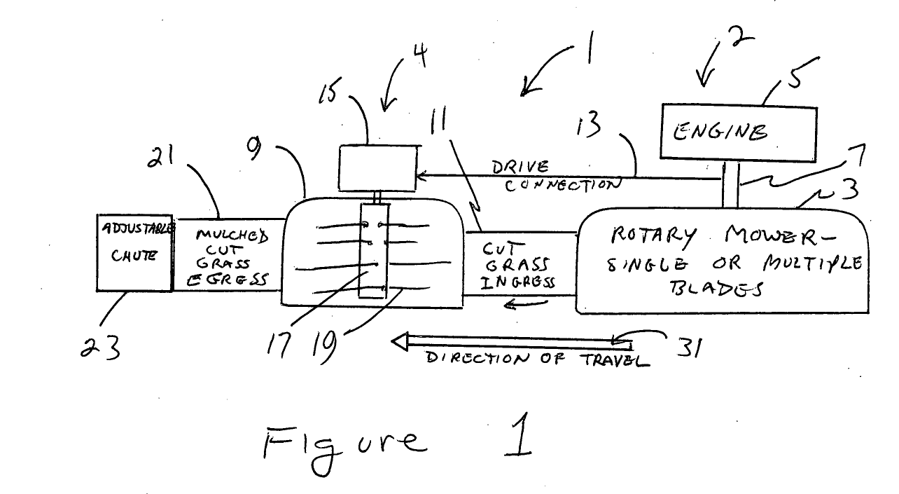

FIG. 1 illustrates a side view diagrammatic representation of one embodiment of a present invention unit 1 that includes a grass mulching device 4 and rotary lawn mower 2. The lawn mower is a rotary lawn mower 2 has a mower housing 3, an engine 5, and a mower blade drive shaft 7. This is shown in diagram form and could have the features of any conventional mower, e.g. walk-behind, stand on, ride on, three-point hitch pull deck, etc. It could have a single blade or multiple cutting chambers with one or more blades in each. It could be gas, diesel, electric or otherwise. In place of the discharge chute to the ground is a tunnel, funnel, throw way or other connection to mulching device 4, in this application referred to as a cut grass ingress, in FIG. 1, cut grass ingress 11 feeding the cut grass into mulching device 4.

Mulching device 4 includes a mulcher main housing 9, a shaft 17, with plurality of mulching lines, such as line 19. It also includes a shaft take-off 15 with a drive connection 13 and this drive connection may be a pulley attachment and pulley, a gear arrangement, a drive shaft arrangement with bevel gears, or any other functional take-off from engine 5 to the mulcher. The direction of travel 31 is shown from left to right and thus, mulched cut-grass egress 21 is located at the front end of unit 1 so that the cut, mulched discharged grass may at least partially be recycled through unit 1 again to create a finer, more efficient mulching. The optional adjustable chute located at the front may be 2 or 3 hinged deflectors that may be locked into various positions for front or side discharge.

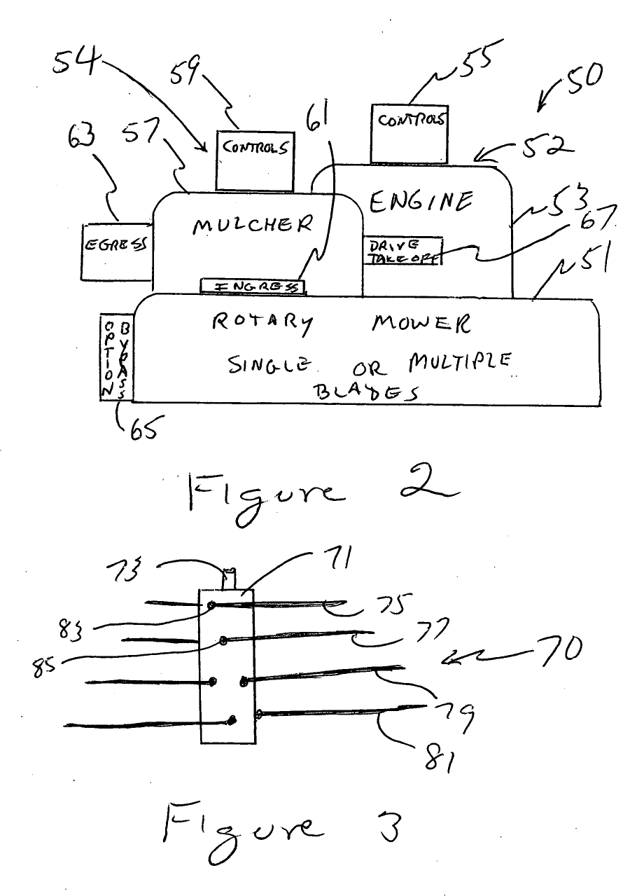

FIG. 2 shows another side view diagrammatic representation of a different embodiment of a present invention unit 50 with grass mulching device 54 and rotary lawn mower 52. Mower 52 has an engine 53 and a mower housing 51 with controls 55 and a take-off 67 that is connected to mulching device 54. Mulching device 54 has an ingress 61 and an egress 63 as well as controls 59 that may include mechanical and/or electric controls, such as a clutch or a switch to engage and disengage motor power from the engine 53.

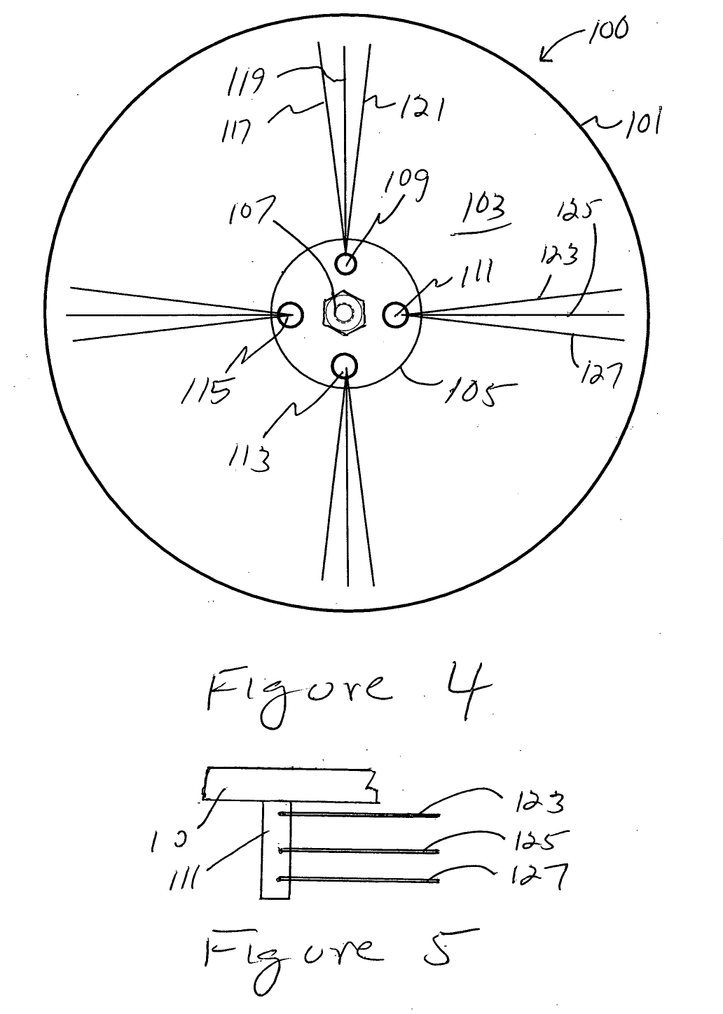

FIG. 3 shows a side view of a present invention mulching device shaft and mulch lines unit 70. Shaft 71 has an upwardly extending drive 73 for connection to a power take-off. Shaft 71 has a plurality of holes and fittages such as holes 83 and 85 with screws or other locking means to secure the mulching lines such as lines 75, 77, 79 and 81. These are metal or plastic whip lines that can be replaced at the fittage. Note that these lines are both in a spiral arrangement and are of different lengths. They could be alternatively of the same or similar lengths and be arranged in any fixed pattern desired. However, the spiral arrangement in FIG. 3 is believed to create a cascading effect in the mulching process.

FIG. 4 shows a bottom view of a present invention mulching device disk shaft arrangement 100 and FIG. 5 shows a partial cut side view thereof. Mulcher housing 101 contains a disk type shaft 105 with four downwardly extending screw-in shafts 109, 111, 113 and 115. Shaft 105 is fixed to drive shaft 107 with a spring washer and nut. Each of the screw-in shafts have a plurality of mulching lines extending therefrom, such as lines 117, 119 and 121 from shaft 109. Referring to both FIG. 4 and FIG. 5, screw-in shaft 111 includes lines 123, 125 and 127 and these are vertically aligned but horizontally may flex.

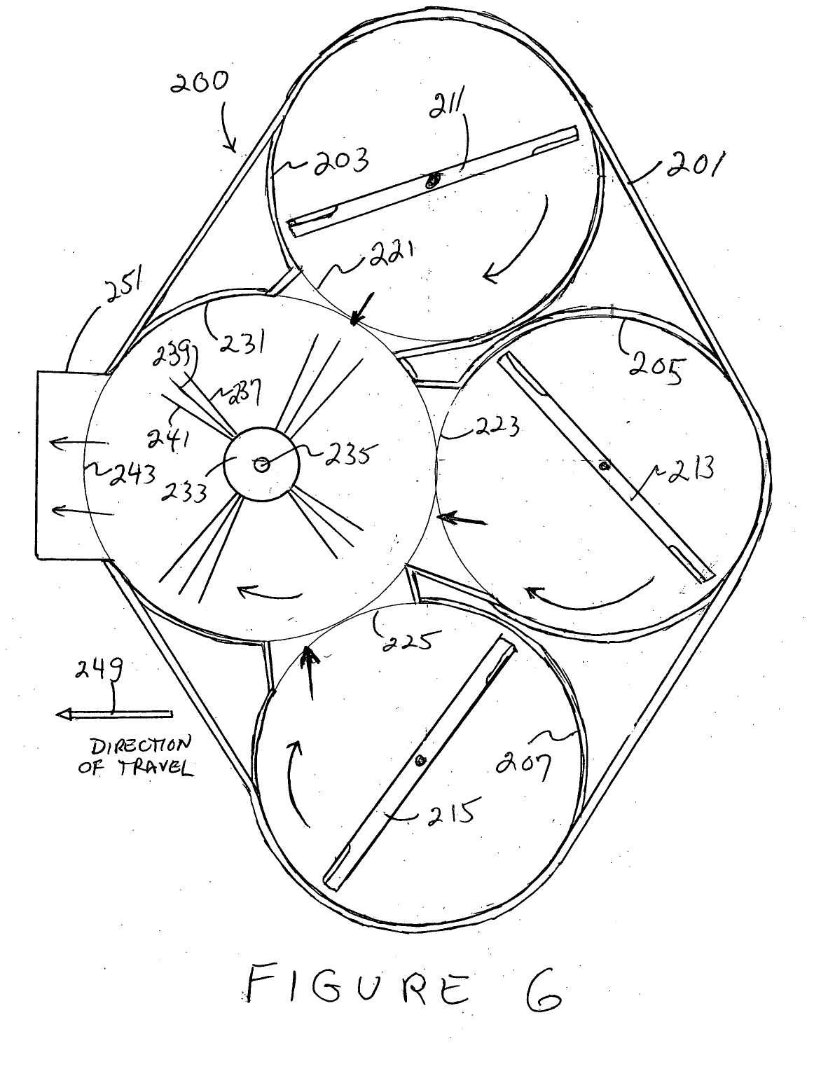

FIG. 6 shows a bottom view of a present invention mulcher and mower unit 200 with a single plane deck 201 and plural cutting chambers 203, 205 and 207, with blades 211, 213 and 215, respectively. Each of the chambers 203, 205 and 207 have exits that connect to cut grass ingress ports or openings, namely ingress ports 221, 223 and 225, respectively. These ports feed into mulching chamber 231, wherein the mulching main housing in this embodiment is the chamber 231. Contained in mulching chamber 231 are a disk type shaft 233 and a drive shaft 235 (connected to the lawn mower engine with a take-off, not shown). The shaft 233 includes four groups of mulching lines, with three in each group, such as lines 237, 239 and 241. This deck mower unit 200 may be a ride on, a three point hitch pull or other type lawn mower and, as can be seen in FIG. 6, discharge of the cut mulched grass is to the front via egress port 243.

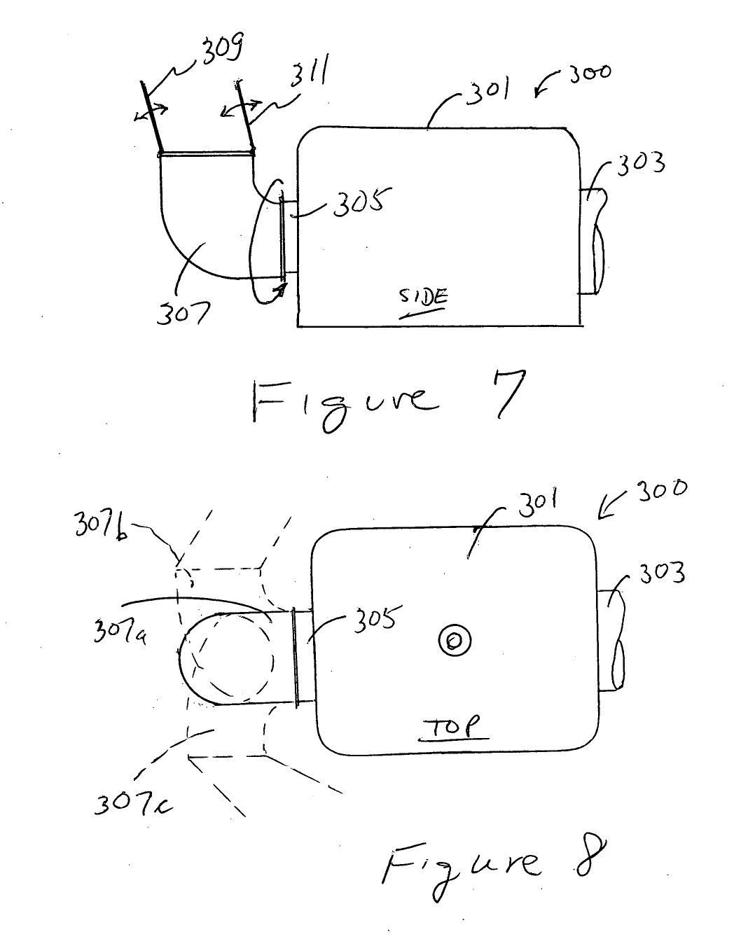

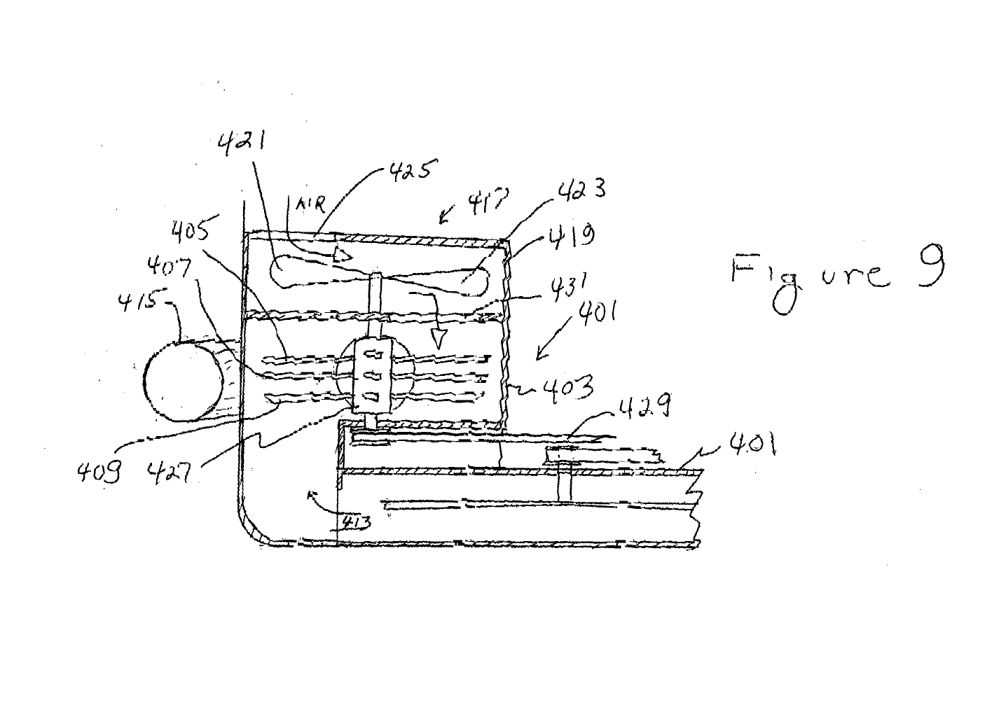

FIGS. 7 and 8 show side and top views of a present invention mulching device 300 with a main housing 301, a grass ingress port 303, and a grass egress port 305, with an adjustable egress port nozzle 307 and adjustable deflectors 309 and 311. In FIG. 7, nozzle 307 is facing up and deflectors 309 and 311 may be repositioned forwardly to effect front discharge or backwardly to effect over-the-top rear discharge. FIG. 8 shows the nozzle in nozzle position 307a in the downward position for front discharge, in nozzle position 307b for right side discharge and in nozzle position 307c for left side discharge. Thus, a user may position the nozzle and deflectors as desired for discharge.

FIG. 9 shows a cut front view of another present invention mulching device 400. It includes a connection to a front 401 of a mower (not shown in its entirety) with a mulcher main housing 403. Mulcher main housing 403 includes a drive shaft 427 with a plurality of metal blades, such as blades 405, 407 and 409. It is driven by left 429 with a connection to the motor of the mower (not shown). There is a grass ingress 413 and a grass egress 415, as shown. Booster blower 417 is located on top of housing 403 and includes a blower housing 419, blower blades 421 and 423, an air inlet 425 and an air input opening 431. This booster blower 417 may be operated by take off from the mower engine and will help to accelerate cut mulched grass removal and prevent clogging.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims. For example, while the shaft of the mulcher device is shown in the drawings and described in a vertical orientation relative to the ground, alternatively, it may be horizontal or may be at a non vertical angle with the ground.

What is claimed is:

1. A recycling grass mulching device for a rotary lawn mower, which comprises:
(a.) a main housing having a grass ingress port and a grass egress port;
(b.) a mulching device contained within said main housing, said mulching device including a central shaft, a central shaft drive take-off, and a plurality of mulching members extending outwardly and away from said central shaft wherein said drive take-off is selected from the group consisting of a pulley attachment, a gear attachment, a chain attachment, and a drive shaft attachment.

2. The recycling grass mulching device for a rotary lawn mower of claim 1 wherein said main housing is adapted to be mounted into a rotary lawn mower with said grass ingress port being connectable to a grass cutting area of said rotary lawn mower.

3. The recycling grass mulching device for a rotary lawn mower of claim 1 wherein said grass ingress is positioned relative to said central shaft so as to feed grass cuttings at approximately a 90 degree angle to said central shaft.

4. The recycling grass mulching device for a rotary lawn mower of claim 1 wherein said mulching members are mulching lines that are selected from the group consisting of flexible plastic lines and metal lines.

5. The recycling grass mulching device for a rotary lawn mower of claim 1 wherein said mulching members are blades.

6. The recycling grass mulching device for a rotary lawn mower of claim 1 wherein said central shaft includes a plurality of rows of mulching lines.

7. The recycling grass mulching device for a rotary lawn mower of claim 6 wherein said plurality of mulching lines is arranged in spiral fashion.

8. The recycling grass mulching device for a rotary lawn mower of claim 1 wherein said main housing is adapted to be attached on top of a rotary lawn mower with said grass egress port being directed to a front area of said rotary lawn mower.

9. The recycling grass mulching device for a rotary lawn mower of claim 1 wherein said grass egress port includes a deflector that is adjustable such that it may be positioned in one of a plurality of possible directions.

10. The recycling grass mulching device for a rotary lawn mower of claim 1 wherein said grass egress port deflector includes a hinge mechanism for multiple positioning thereof.

11. The recycling grass mulching device for a rotary lawn mower of claim 1 wherein said main housing is located within a cutting housing of a rotary lawn mower.

12. The recycling grass mulching device for a rotary lawn mower of claim 11 wherein said grass ingress port is connected to a rotary blade cutting area and said grass egress port is positioned to eject mulched grass in front of said rotary lawn mower.

13. The recycling grass mulching device for a rotary lawn mower of claim 1 wherein said device further includes an auxiliary blower connected to said main housing.

14. A recycling grass mulching device and a rotary lawn mower, which comprises:
(a.) a rotary lawnmower, including a mower housing, a motor, a mower blade and a drive mechanism connecting said motor to said mower blade, and further including connection to a mulcher main housing grass ingress port;
(b.) a mulcher main housing having a grass ingress port and a grass egress port, connected to said rotary lawn mower;
(c.) a mulching device contained within said main housing, said mulching device including a central shaft, a central shaft drive take-off, and a plurality of mulching lines extending outwardly and away from said central shaft wherein said drive take-off is selected from the group consisting of a pulley attachment, a gear attachment, a chain attachment, and a drive shaft attachment.

15. The recycling grass mulching device and a rotary lawn mower of claim 14 wherein said main housing is mounted in a position selected from the group consisting of atop said mower housing, in front of said mower housing and a combination thereof.

16. The recycling grass mulching device and a rotary lawn mower of claim 14 wherein said grass ingress is positioned relative to said central shaft so as to feed grass cuttings at approximately a 90 degree angle to said central shaft.

17. The recycling grass mulching device and a rotary lawn mower of claim 14 wherein said mulching member are selected from the group consisting of blades, flexible plastic lines and metal lines.

18. The recycling grass mulching device and a rotary lawn mower of claim 13 wherein said grass egress port is adjustable and includes a forward egress position, a left side egress position and a right side egress position.

19. The recycling grass mulching device and a rotary lawn mower of claim 13 wherein said mulcher main housing and said mower housing are located in the same plane and said mulcher main housing is positioned in front of said mower housing.

20. The recycling-grass mulching device and a rotary lawn mower of claim 19 wherein said mower housing includes a plurality of cutting blades located in a plurality of chambers with each of said plurality of chambers being connected to a grass ingress port of said mulcher main housing.
